(19) United States
(12) Patent Application Publication
(10) Pub. No.: US 2010/0028222 A1
(43) Pub. Date: Feb. 4, 2010

(54) Catalytic conditioner for fuel

(76) Inventor: Robert O. Crane, Corpus Christi, TX (US)

Correspondence Address: Derek R. Van Gilder, 916 Main St., Bastrop, TX, 78602, US

(21) Appl. No.: 11/648,022

(22) Filed: Apr. 3, 2007

(51) Int. Cl. B01J 19/08; B01J 35/02

(52) U.S. Cl. 422/186.04; 422/222

(57) ABSTRACT

A catalytic fuel conditioner has an insulated conveyance (1) for containing fuel-conditioning catalytic material with either of a selection of liquid-contact structures (7, 11, 12, 13, 14) which are electrically insulated at an inside periphery of the insulated conveyance. The fuel-conditioning catalytic material is structured designedly for predeterminedly random contact of liquid fuel being conveyed intermediate an inlet end (4) and an outlet end (6) of the insulated conveyance. Optionally for conditioning particular liquid fuels, electrical current can be routed through the fuel-conditioning catalytic material.

### FIELD OF THE INVENTION

This invention relates to pre-combustion catalytic conditioners of engine fuel for increasing fuel-use efficiency and for decreasing exhaust pollutants.

### BACKGROUND OF THE INVENTION

### Relation to Prior Art

This is a pre-combustion catalytic fuel conditioner for heat engines. Catalytic pre-combustion conditioning of engine fuel is well known, but has not been successful because need for effective electrical insulation of the fuel conditioning and of the conditioned fuel were not known nor utilized previously. Also not known nor utilized previously have been more effective structure of catalytic elements in a manner taught by this invention.

Known catalytic conditioners for fuel, water and liquids generally without these improvements include the following patent documents:

| Patent Number | Inventor | Disclosure Date |
|---|---|---|
| U.S. Pat. No. 4,715,325 | Walker | December 1987 |
| U.S. Pat. No. 4,789,031 | Walker | December 1988 |
| U.S. Pat. No. 6,267,883 | Weaver, et al. | July 2001 |
| U.S. Pat. No. 5,048,499 | Drywalt | September 1991 |

### SUMMARY OF THE INVENTION

Objects of patentable novelty and utility taught by this invention are to provide a catalytic fuel conditioner which:

decreases fuel consumption per power of heat engines;

decreases metal corrosion of heat engines;

decreases buildup of extraneous material from fuel on heat engines;

increases efficiency of catalytic conditioning by electrically insulating the catalytic conditioning process;

provides randomly high rate of contact of fuel with catalytic material; and

provides optional electrical current for enhancement of catalytic effects on particular fuels.

This invention accomplishes these and other objectives with a catalytic fuel conditioner having an insulated conveyance containing fuel-conditioning catalytic material that is electrically insulated at an inside periphery of the insulated conveyance. The fuel-conditioning catalytic material is structured designedly for predeterminedly random contact of liquid fuel intermediate an entry and an exit of the insulated conveyance. The insulated conveyance can be short and wide with a relatively cannister shape or long and narrow with a relatively tubular shape predeterminedly. Optionally for conditioning particular liquid fuels, electrical current can be routed through the fuel-conditioning catalytic material. Structure of the fuel-conditioning catalytic material for random contact with liquid fuel can include a selection of mesh, configurations and plates with circulation apertures.

### BRIEF DESCRIPTION OF DRAWINGS

This invention is described by appended claims in relation to description of preferred embodiments with reference to the following drawings which are referred to as FIGS. and explained briefly as follows:

FIG. 1 is a partially cutaway elevation view of a canister embodiment having catalytic fuel conditioning material that is metal cuttings positioned intermediate a fuel inlet and a fuel outlet.

FIG. 2 is a partially cutaway elevation view of a longer cannister tube embodiment having the catalytic fuel conditioning material that is metal cuttings positioned intermediate a fuel inlet and a fuel outlet.

FIG. 3 is a partially cutaway elevation view of the canister embodiment having the catalytic fuel conditioning material being metal wire positioned intermediate the fuel inlet and the fuel outlet.

FIG. 4 is a partially cutaway elevation view of the tube embodiment having the catalytic fuel conditioning material being the metal wire positioned intermediate the fuel inlet and the fuel outlet.

FIG. 5 is a partially cutaway elevation view of the canister embodiment having the catalytic fuel conditioning material being a plurality of metal configurations positioned intermediate the fuel inlet and the fuel outlet.

FIG. 6 is a partially cutaway elevation view of the tube embodiment having the catalytic fuel conditioning material being the plurality of the metal configurations positioned intermediate the fuel inlet and the fuel outlet.

FIG. 7 is a partially cutaway elevation view of the canister embodiment having the catalytic fuel conditioning material being a plurality of metal plates positioned intermediate the fuel inlet and the fuel outlet.

FIG. 8 is a partially cutaway elevation view of the tube embodiment having the catalytic fuel conditioning material being the plurality of the metal plates positioned intermediate the fuel inlet and the fuel outlet.

FIG. 9 is an enlarged elevation view of one of the plurality of metal configurations of the embodiments of FIGS. 5-6 being a metal structure with six prongs.

FIG. 10 is a top view of one of the plurality of metal plates of the embodiment of FIG. 8 having peripheral orifices.

FIG. 11 is a top view of one of the plurality of metal plates of the embodiment of FIG. 8 having a central orifice.

FIG. 12 is a top view of one of the plurality of metal plates of the embodiment of FIG. 7 having the peripheral orifices.

FIG. 13 is a top view of one of the plurality of metal plates of the embodiment of FIG. 7 having a central orifice.

FIG. 14 is an enlarged partially cutaway side view of the plurality of the metal plates for the embodiments of FIGS. 7-8.

### DESCRIPTION OF PREFERRED EMBODIMENT

This invention is described with reference to numbered terms which designate its features with the same numbers for the drawings and in parentheses throughout the description and throughout descriptive patent claims.

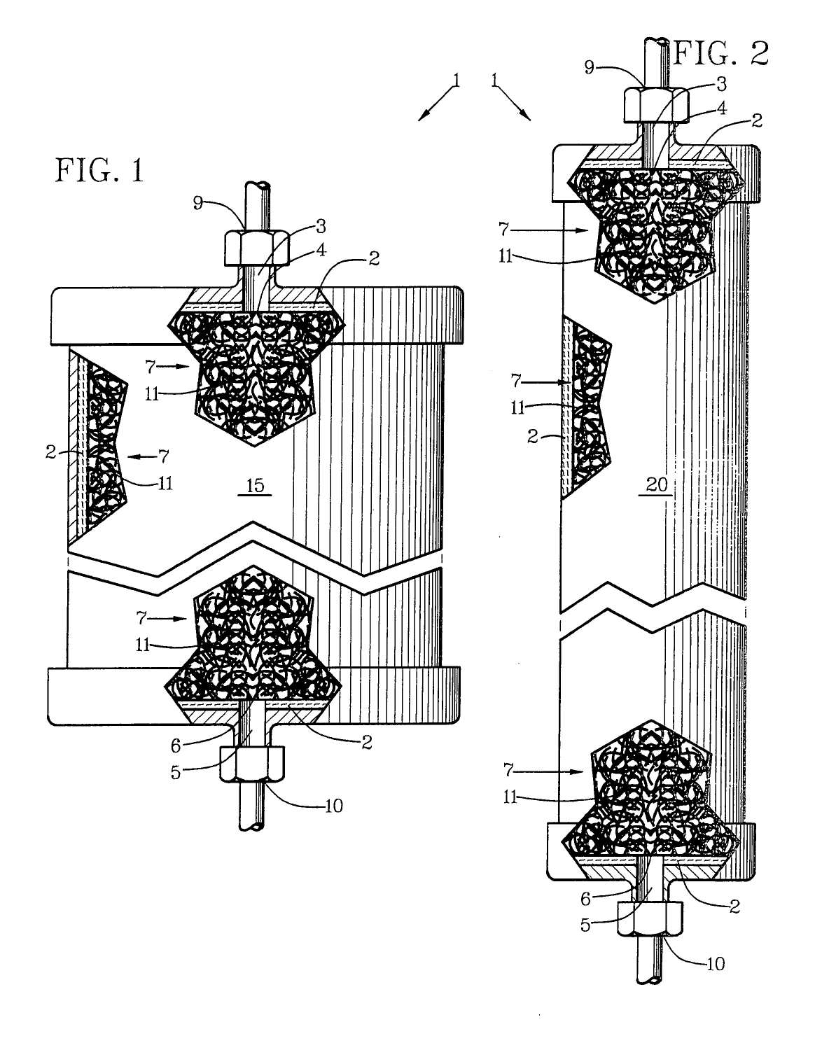

Referring to FIG. 1, an insulated conveyance (1) has an electrically insulated inside periphery that is insulated with electrical insulation (2). A fuel inlet (3) is positioned proximate an inlet end (4) and a fuel outlet (5) is positioned proximate an outlet end (6) of the insulated conveyance (1).

A catalytic fuel-conditioning material (7) is positioned predeterminedly intermediate the inlet end (4) and the outlet end (6) of the insulated conveyance (1). The catalytic fuel-conditioning material (7) has either of a selection of liquid-conveyance structures for predeterminedly random conveyance of liquid in contact with the catalytic fuel-conditioning material (7).

A conditioner inlet connector (9) is in connective communication with the fuel inlet (3) and a conditioner outlet connector (10) is in connective communication with the fuel outlet (5).

The catalytic fuel-conditioning material (7) is an alloy having by weight 40-60% copper and a complimentary 40-60% by weight being one or more predetermined metals having low electrical conductivity.

Referring to FIGS. 1-2, the selection of liquid-contact structures includes metal-machine cuttings (11) having a predetermined size range in mesh arrangement with predetermined closeness and contact for the predeterminedly random conveyance of liquid in contact with the catalytic fuel-conditioning material (7).

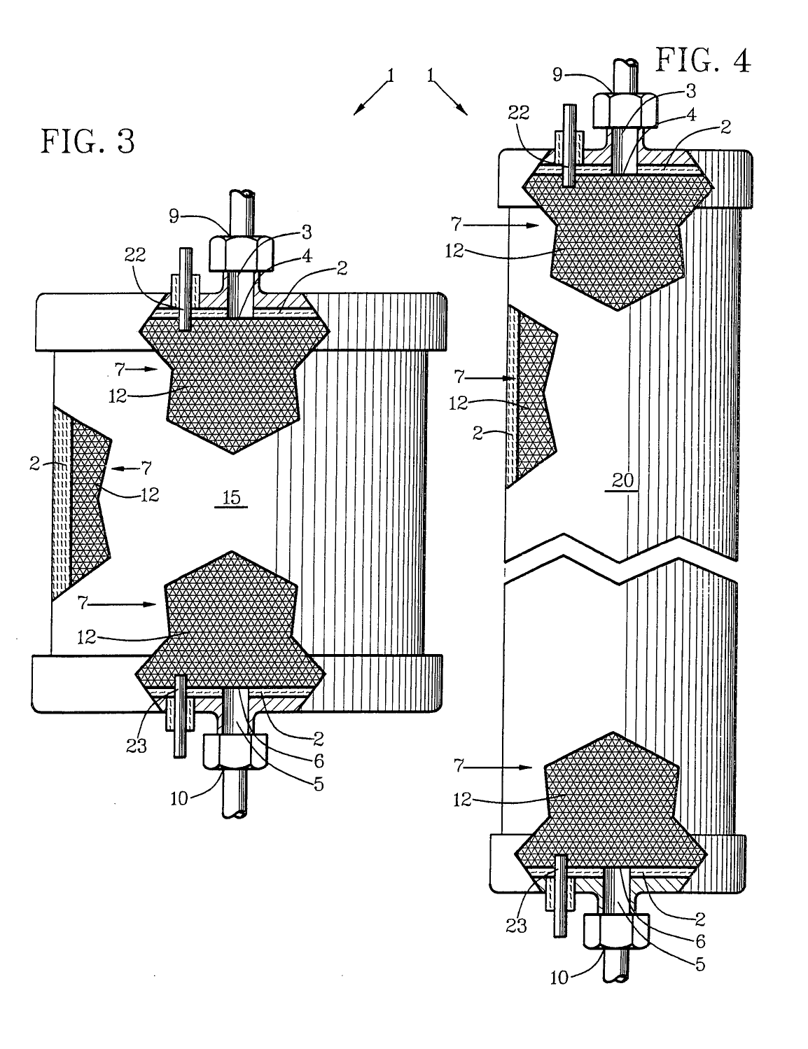

Referring to FIGS. 3-4, the selection of liquid-contact structures includes metal wire (12) having predetermined gage size in mesh arrangement with predetermined closeness and contact for the predeterminedly random conveyance of liquid in contact with the catalytic fuel-conditioning material (7).

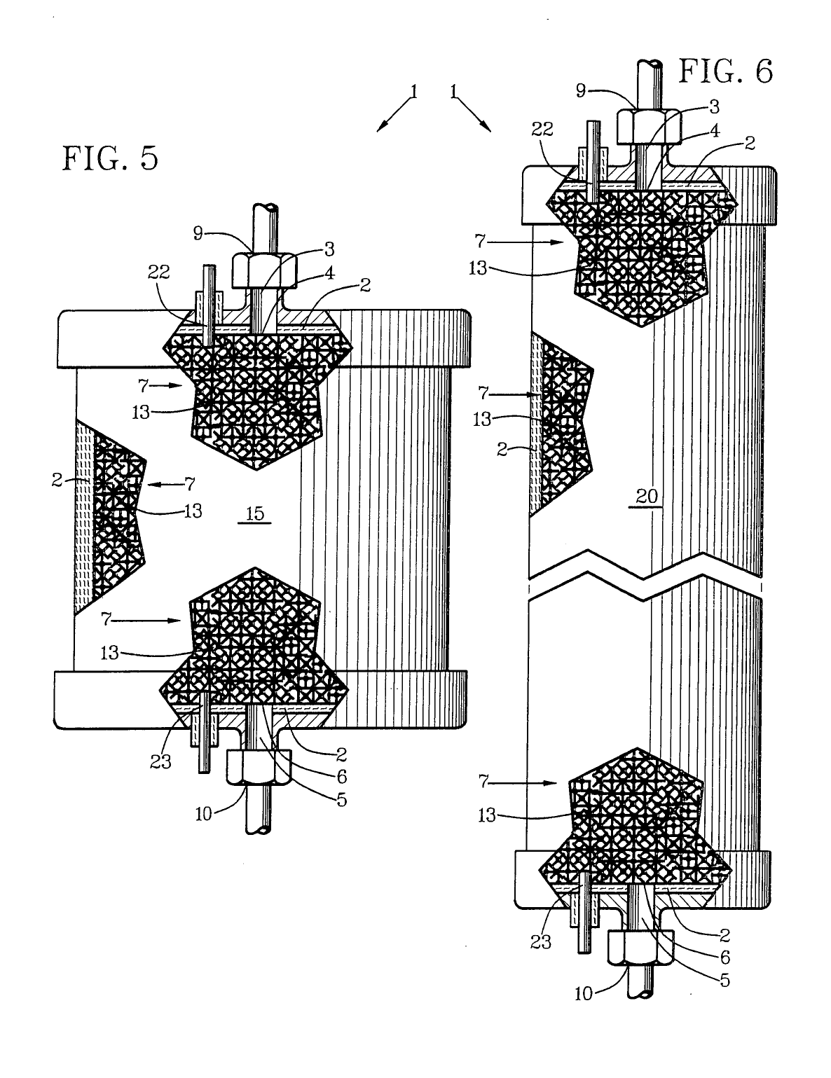

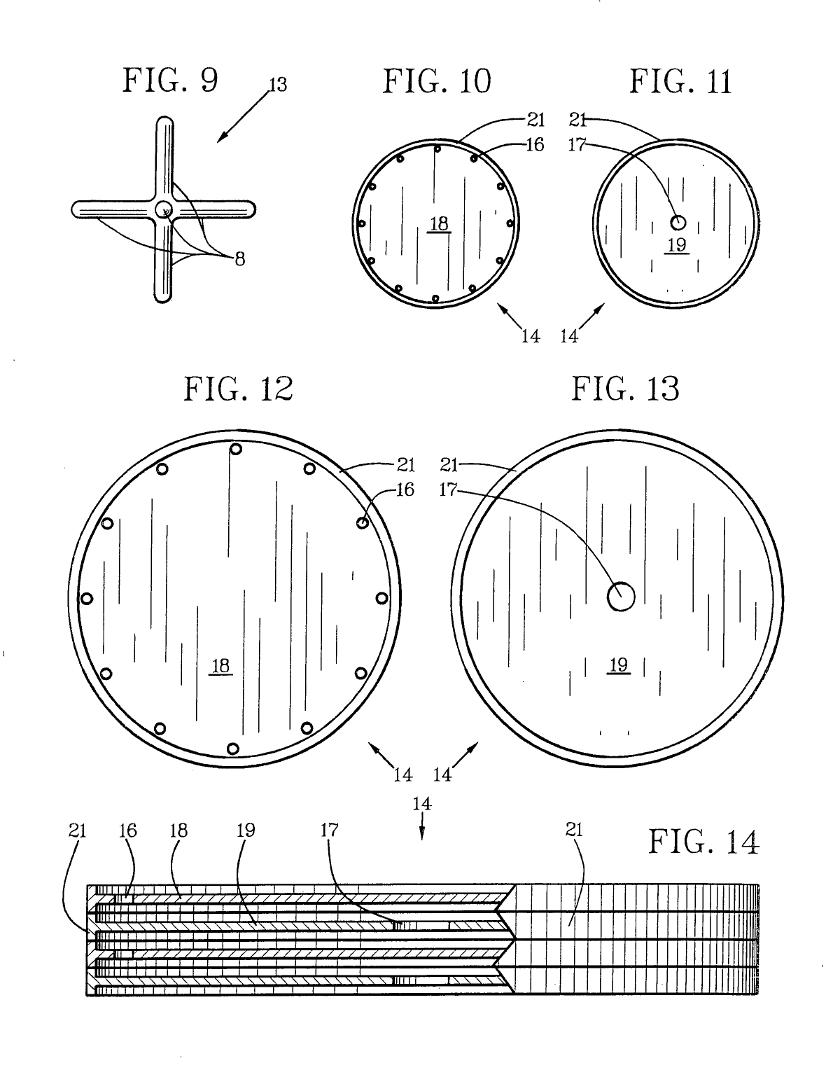

Referring to FIGS. 5-6 and 9, the selection of liquid-contact structures includes a plurality of metal configurations (13) having predetermined size and shape in contact arrangement for the predeterminedly random conveyance of liquid in contact with the catalytic fuel-conditioning material (7). As shown enlarged for detail illustration in FIG. 9, the metal configurations (13) can have six metal prongs (8). Also included can be randomly gravel-shaped or sand-shaped structures of the catalytic fuel-conditioning material (7).

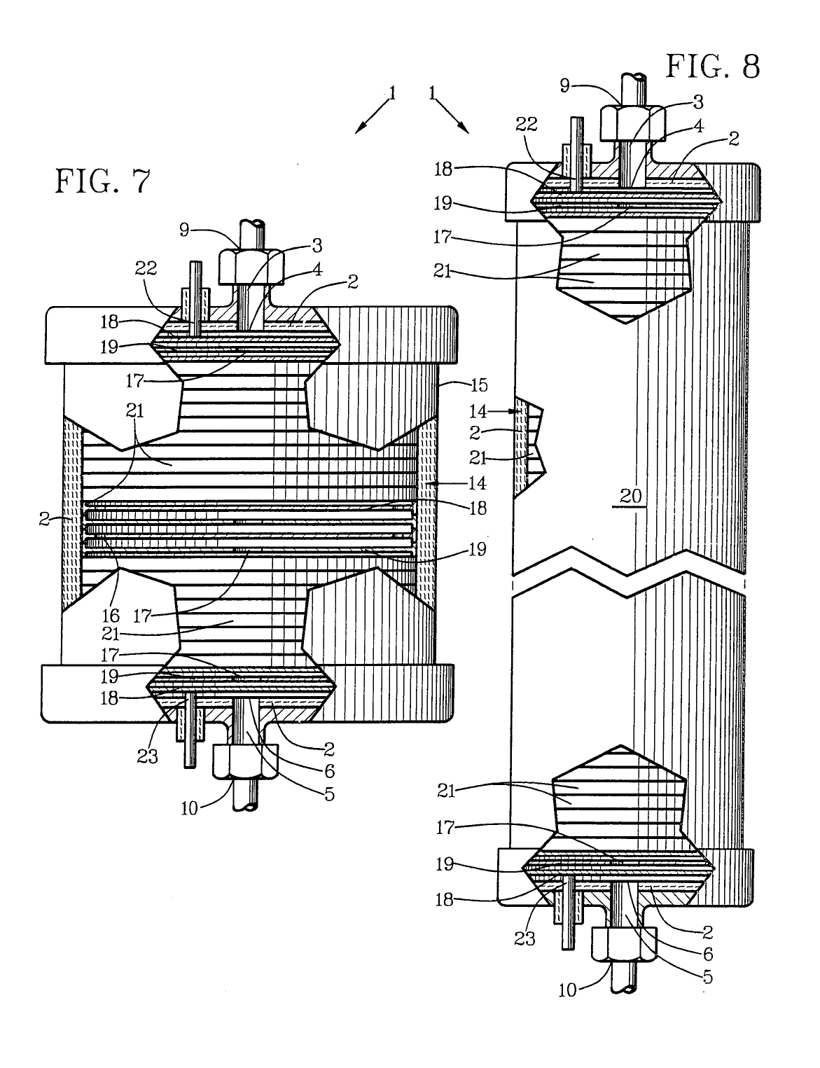

Referring to FIGS. 7-8 and 10-14, the selection of liquid-contact structures includes a plurality of metal plates (14) having predetermined size and shape with predetermined apertures for the predeterminedly random conveyance of liquid in contact with the catalytic fuel-conditioning material (7). Preferably, the metal plates (14) include first plates (18) separated alternately from second plates (19) by separation rims (21) for allowing flow of fuel through first-plate apertures (16) and through second-plate apertures (17) that are offset to cause flow of fuel across the first plates (18) and the second plates (19) for changing flow directions alternately between the first plates (18) and the second plates (19) for maximized fuel-conditioning contact intermediate the fuel inlet (3) and the fuel outlet (5). A preferred offset arrangement is positioning the first-plate apertures (16) peripherally and the second-plate apertures (17) centrally as illustrated. The separation rims (21) can be positioned on either or both sides of the first plates (18) and the second plates (19).

The predetermined metals having low electrical conductance can include 10-25% nickel, 2-30% zinc, 1-5% tin, 0-1.5% iron and 0-1% lead.

Referring to FIGS. 1, 3, 5 and 7, the insulated conveyance (1) includes a cannister (15) having a cannister length predeterminedly one-to-three times a cannister cross-sectional width as depicted.

Referring to FIGS. 2, 4, 6 and 8, the insulated conveyance (1) includes a tube (20) having a tube length predeterminedly three-to-ten times a tube cross-sectional width as depicted.

Referring to FIGS. 3-8, optionally for conditioning particular liquids, an inlet electrical connector (22) proximate the inlet end (4) and an outlet electrical connector (23) proximate the outlet end (6) can be positioned in electrical contact with the fuel-conditioning material (7) for conveying electrical current through the catalytic fuel-conditioning material (7) predeterminedly.

A new and useful catalytic fuel conditioner having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A catalytic fuel conditioner comprising:
an insulated conveyance (1) having an electrically insulated inside periphery insulated with electrical insulation (2);
a fuel inlet (3) proximate an inlet end (4);
a fuel outlet (5) proximate an outlet end (6);
catalytic fuel-conditioning material (7) positioned predeterminedly intermediate the inlet end (4) and the outlet end (6) of the insulated conveyance (1);
the catalytic fuel-conditioning material (7) having liquid-contact structure for predeterminedly random conveyance of liquid in contact with the catalytic fuel-conditioning material (7);
a conditioner inlet connector (9) in connective communication with the fuel inlet (3);
a conditioner outlet connector (10) in connective communication with the fuel outlet (5); and
the catalytic fuel-conditioning material (7) is an alloy having by weight 40-60% copper and a complimentary 40-60% by weight being one or more predetermined metals having low electrical conductance.

2. The catalytic fuel conditioner of claim 1 in which:
the liquid-contact structure is metal-machine cuttings (11) having a predetermined size range in mesh arrangement with predetermined closeness and contact for the predeterminedly random conveyance of liquid in contact with the catalytic fuel-conditioning material (7).

3. The catalytic fuel conditioner of claim 1 in which:
the liquid-contact structure is metal wire (12) having predetermined gage size in mesh arrangement with predetermined closeness and contact for the predeterminedly random conveyance of liquid in contact with the catalytic fuel-conditioning material (7).

4. The catalytic fuel conditioner of claim 1 in which:
the liquid-contact structure is a plurality of metal configurations (13) having predetermined size and shape in contact arrangement for the predeterminedly random conveyance of liquid in contact with the catalytic fuel-conditioning material (7).

5. The catalytic fuel conditioner of claim 1 in which:
the liquid-contact structure is a plurality of metal plates (14) having predetermined size and shape with first-plate apertures (16) in first plates (18) offset from second-plate apertures (17) in alternately second plates (19) comprising the metal plates (14); and
the metal plates (14) have separation rims (21) for allowing predetermined conveyance of liquid in contact with the catalytic fuel-conditioning material (7) intermediate the metal plates (14).

6. The catalytic fuel conditioner of claim 1 in which:
the predetermined metals having low electrical conductance are 10-25% nickel, 2-30% zinc, 1-5% tin, 0-1.5% iron and 0-1% lead.

7. The catalytic fuel conditioner of claim 1 in which:
the insulated conveyance (1) is a cannister (15) having a cannister length predeterminedly one-to-three times a cannister cross-sectional width.

8. The catalytic fuel conditioner of claim 1 in which:
the insulated conveyance (1) is a tube (20) having a tube length predeterminedly three-to-ten times a tube cross-sectional width.

9. The catalytic fuel conditioner of claim 1 in which:
an inlet electrical connector (22) and an outlet electrical connector (23) are positioned in electrical contact with the liquid-contact structure for conveying electrical current through the catalytic fuel-conditioning material (7) predeterminedly.

10. A catalytic fuel conditioner comprising:
an insulated conveyance (1) having an electrically insulated inside periphery insulated with electrical insulation (2);
a fuel inlet (3) proximate an inlet end (4);
a fuel outlet (5) proximate an outlet end (6);
catalytic fuel-conditioning material (7) positioned predeterminedly intermediate the inlet end (4) and the outlet end (6) of the insulated conveyance (1);
the catalytic fuel-conditioning material (7) having liquid-contact structure for predeterminedly random conveyance of liquid in contact with the catalytic fuel-conditioning material (7);
a conditioner inlet connector (9) in connective communication with the fuel inlet (3);
a conditioner outlet connector (10) in connective communication with the fuel outlet (5);
the catalytic fuel-conditioning material (7) is an alloy having by weight 40-60% copper and a complimentary 40-60% by weight being one or more predetermined metals having low electrical conductance;
the predetermined metals having low electrical conductance are 10-25% nickel, 2-30% zinc, 1-5% tin, 0-1.5% iron and 0-1% lead; and
the insulated conveyance (1) is a cannister (15) having a cannister length predeterminedly one-to-three times a cannister cross-sectional width.

11. The catalytic fuel conditioner of claim 10 in which:
the liquid-contact structure is metal-machine cuttings (11) having a predetermined size range in mesh arrangement with predetermined closeness and contact for the predeterminedly random conveyance of liquid in contact with the catalytic fuel-conditioning material (7).

12. The catalytic fuel conditioner of claim 10 in which:
the liquid-contact structure is metal wire (12) having predetermined gage size in mesh arrangement with predetermined closeness and contact for the predeterminedly random conveyance of liquid in contact with the catalytic fuel-conditioning material (7).

13. The catalytic fuel conditioner of claim 10 in which:
the liquid-contact structure is a plurality of metal configurations (13) having predetermined size and shape in contact arrangement for the predeterminedly random conveyance of liquid in contact with the catalytic fuel-conditioning material (7).

14. The catalytic fuel conditioner of claim 10 in which:
an inlet electrical connector (22) and an outlet electrical connector (23) are positioned in electrical contact with the liquid-contact structure for conveying electrical current through the catalytic fuel-conditioning material (7) predeterminedly.

15. The catalytic fuel conditioner of claim 10 in which:
the liquid-contact structure is a plurality of metal plates (14) having predetermined size and shape with first-plate apertures (16) in first plates (18) offset from second-plate apertures (17) in alternately second plates (19) comprising the metal plates (14); and
the metal plates (14) have separation rims (21) for allowing predetermined conveyance of liquid in contact with the catalytic fuel-conditioning material (7) intermediate the metal plates (14).

16. The catalytic fuel conditioner of claim 14 in which:
the liquid-contact structure is a plurality of metal plates (14) having predetermined size and shape with first-plate apertures (16) in first plates (18) offset from second-plate apertures (17) in alternately second plates (19) comprising the metal plates (14); and
the metal plates (14) have separation rims (21) for allowing predetermined conveyance of liquid in contact with the catalytic fuel-conditioning material (7) intermediate the metal plates (14).

17. The catalytic fuel conditioner of claim 14 in which:
the liquid-contact structure is metal-machine cuttings (11) having a predetermined size range in mesh arrangement with predetermined closeness and contact for the predeterminedly random conveyance of liquid in contact with the catalytic fuel-conditioning material (7).

18. A catalytic fuel conditioner comprising:
an insulated conveyance (1) having an electrically insulated inside periphery insulated with electrical insulation (2);
a fuel inlet (3) proximate an inlet end (4);
a fuel outlet (5) proximate an outlet end (6);
catalytic fuel-conditioning material (7) positioned predeterminedly intermediate the inlet end (4) and the outlet end (6) of the insulated conveyance (1);
the catalytic fuel-conditioning material (7) having liquid-contact structure for predeterminedly random conveyance of liquid in contact with the catalytic fuel-conditioning material (7);
a conditioner inlet connector (9) in connective communication with the fuel inlet (3);
a conditioner outlet connector (10) in connective communication with the fuel outlet (5);
the insulated conveyance (1) is a tube (20) having a tube length predeterminedly three-to-ten times a tube cross-sectional width;
the catalytic fuel-conditioning material (7) is an alloy having by weight 40-60% copper and a complimentary 40-60% by weight being one or more predetermined metals having low electrical conductance; and
the predetermined metals having low electrical conductance are 10-25% nickel, 2-30% zinc, 1-5% tin, 0-1.5% iron and 0-1% lead.

19. The catalytic fuel conditioner of claim (18) in which:
the liquid-contact structure is metal-machine cuttings (11) having a predetermined size range in mesh arrangement with predetermined closeness and contact for the predeterminedly random conveyance of liquid in contact with the catalytic fuel-conditioning material (7).

20. The catalytic fuel conditioner of claim 18 in which:
the liquid-contact structure is metal wire (12) having predetermined gage size in mesh arrangement with predetermined closeness and contact for the predeterminedly random conveyance of liquid in contact with the catalytic fuel-conditioning material (7).

21. The catalytic fuel conditioner of claim 18 in which:
the liquid-contact structure is a plurality of metal configurations (13) having predetermined size and shape in contact arrangement for the predeterminedly random conveyance of liquid in contact with the catalytic fuel-conditioning material (7).

22. The catalytic fuel conditioner of claim 18 in which:
an inlet electrical connector (22) and an outlet electrical connector (23) are positioned in electrical contact with the liquid-contact structure for conveying electrical current through the catalytic fuel-conditioning material (7) predeterminedly.

23. The catalytic fuel conditioner of claim (22) in which:
the liquid-contact structure is metal-machine cuttings (11) having a predetermined size range in mesh arrangement with predetermined closeness and contact for the predeterminedly random conveyance of liquid in contact with the catalytic fuel-conditioning material (7).

24. The catalytic fuel conditioner of claim (22) in which:
the liquid-contact structure is a plurality of metal plates (14) having predetermined size and shape with first-plate apertures (16) in first plates (18) offset from second-plate apertures (17) in alternately second plates (19) comprising the metal plates (14); and
the metal plates (14) have separation rims (21) for allowing predetermined conveyance of liquid in contact with the catalytic fuel-conditioning material (7) intermediate the metal plates (14).
